(19) United States
(12) Patent Application Publication
(10) Pub. No.: US 2002/0107970 A1
(43) Pub. Date: Aug. 8, 2002

(54) Method of and apparatus for remotely preparing a targeted procedures model for transforming a data stream

(76) Inventors: David Wiegand, Edmonds, WA (US); Lewis J. Rompala, Spicewood City, TX (US)

Correspondence Address: Sam Pasternack, Choate, Hall & Stewart, Exchange Place, 53 State Street, Boston, MA, 02109, US

(21) Appl. No.: 09/778,703

(22) Filed: Feb. 7, 2001

(51) Int. Cl. G06F 15/16

(52) U.S. Cl. 709/231; 709/218

(57) ABSTRACT

A method of and apparatus for remotely preparing a targeted procedures model for transforming a data stream. The invention employs a telemodeler site communicatively connected to a prospect site and an Internet host. A telemodeler remotely prepares the targeted procedures model by executing steps including collecting prospect information, reviewing existing data streams, determining input and output parameters, designing transformed data streams, documenting the business process flow in the targeted procedures model, reviewing the model with the prospect, deciding whether the prospect approves the model, obtaining the prospect's approval, and providing a firm price and schedule.

### FIELD OF THE INVENTION

The present invention relates generally to a method and apparatus for remotely preparing a targeted procedures model for transforming a data stream. More specifically, the invention assists in providing a “road map” to a prospect to document the proposed conversion of the operation and organization of an existing host application to another organization and operation. The invention has potential application in the field of business software.

### BACKGROUND OF THE INVENTION

Data stream transformation is a method of converting the operation and organization of an existing host application to another organization and operation. Data stream transformation allows better functionality or provides new operations that the previous system could not.

In traditional methods of creating new interfaces or modifying application interfaces, it is generally assumed that existing systems have to be altered in the process. Therefore, numerous validations and tests are included in the methodology to ensure that the underlying functionality of the host application is not impaired. Examples of items that require checking include database formats, source code, business rules, table names, and definitions. Two primary concerns throughout the traditional methods are minimizing the negative impacts of the process and obtaining customer approval for all the changes to be made to the system. The traditional approach also requires considerable time spent meeting with the key customer personnel to determine the nature of changes to be made. This usually involves repeated travel and labor throughout the project.

The traditional methods are inefficient and time consuming, and generate a significant added cost of development, testing, validation, and customer approval. The company that develops a more efficient approach will satisfy customers more consistently.

The transformation of a data stream requires a considerable amount of interaction between the data stream transformation company and the prospective customer (hereinafter, the “prospect”). The proposed data stream transformation is ultimately described and detailed in a document called a Targeted Procedures Model (TPM), and is submitted to the prospect for review and approval. However, this entire process is often conducted at the prospect's location, which incurs significant travel time and labor costs for the data stream transformation company. What is needed is a way to remotely develop a TPM for a data stream transformation.

Because the method of modeling a data stream transformation calls for access to the underlying host application, the host application performance could be negatively impacted or corrupted as a result. What is needed is a way to avoid corrupting a host application in the course of modeling the transformation of a data stream.

Collecting all the information needed to conduct a data stream transformation takes a great deal of time and effort. Extensive information on the underlying host application, including database tables, business rules, source code, algorithms, and table names, must be provided and discussed in detail, since the data stream transformation may affect each one. The prospect also must participate in the discussions and approve the TPM prior to conducting the data stream transformation. These tasks can take months to accomplish. What is needed is a way to more quickly and efficiently develop a TPM for conducting a data stream transformation.

Traditional methods of creating new interfaces or modifying application interfaces do not lead to a clear understanding by the prospect of how the host application operated prior to the data stream transformation. Therefore, it is difficult for the client to fully understand or appreciate what the new functionality will be after a data stream is transformed. What is needed is a way to assist a prospect to better understand the host application and how the host application relates to a data stream transformation.

Without a clear “before” and “after” picture, it is difficult for a prospect to visualize the results of a data stream transformation. What is needed is a way to help a prospect visualize a data stream transformation as it relates to the current application.

In the course of executing a project to transform a data stream, it is important to provide a detailed description of the transformation. Failure to do so can result in the transformation of a data stream that was not what the prospect expected. What is needed is a way to accurately document a data stream transformation.

One way to solve these problems is to use traditional paper-based methods to execute a TPM for data stream transformation. However, these methods do not provide the advantages of remote operations or electronic review that the present invention provides.

### SUMMARY OF THE INVENTION

The present invention is a method of and system for remotely preparing a TPM for transforming one or more data streams. The TPM provides a “road map” to a prospect to document the proposed data stream transformation and to allow for a prospect's review and approval. It is developed in a manner that preserves the integrity of one or more underlying host applications, and does not require source code modification to operate.

In one aspect, the invention is a system for remotely preparing a TPM for transforming data streams. The system comprises a telemodeler site, a prospect site and an Internet host. The telemodeler site includes a phone, a fax machine, and a telemodeler computer including a modem, an email client and a Web browser. The prospect site includes a prospect phone, prospect fax machine, and a host computer communicatively connected to the telemodeler computer including a data storage device, a prospect modem, database, host applications and data streams, prospect email client and a Web browser. Preferably, the Internet host stores the TPM and is communicatively connected to the telemodeler computer and host computer. A telemodeler situated at the telemodeler site remotely prepares the TPM by executing the steps of: collecting prospect information regarding data streams at the prospect site, using the phone, fax machine and/or email client; reviewing the prospect information regarding data streams and/or accessing the host computer directly via the modem to view the host applications and review the data streams in operation to determine goals; determining input and output parameters necessary to satisfy and update the data streams and exercising the host application; designing transformed data streams using the input and output parameters that satisfies the goals; documenting the data streams, input and output parameters, proposed transformed data streams and the goals in the targeted procedures model on the Internet host; reviewing the targeted procedures model with a prospect; deciding whether the prospect approves the targeted procedures model, and if the prospect does not approve returning to the documenting step; obtaining the prospect's signoff/approval; and providing a firm price and schedule. The telemodeler computer may be communicatively connected to the host computer via the Internet.

In another aspect, the invention is a method for using the system described above to remotely prepare a TPM for transforming a prospect's data streams, comprising the method steps recited above.

The invention avoids corrupting a host application in the course of modeling the transformation of a data stream and improves the reliability of delivering a data stream transformation solution. The invention also assists a prospect to better understand their internal processes and visualize a data stream transformation as it relates to their current application, and mobilizes the prospect's personnel and solicits their support during the data stream transformation modeling process. The invention also generates a firm price and schedule for a data stream transformation project in a remarkably short time, and determines if the data stream transformation needs of a prospect fit current capabilities or require further development.

### BRIEF DESCRIPTION OF THE DRAWINGS

FIG. 1 is a schematic diagram illustrating a system for preparing a targeted procedures model for a data stream transformation.

FIG. 2 is a flow diagram illustrating a method of preparing a targeted procedures model for a data stream transformation.

### DETAILED DESCRIPTION

Preferred embodiments of the invention will now be described with reference to the accompanying drawings. The teachings of the applicant's U.S. Pat. Nos. 5,627,977 and 5,889,516, directed to a “trainable user interface translator” are herein incorporated by reference in their entirety.

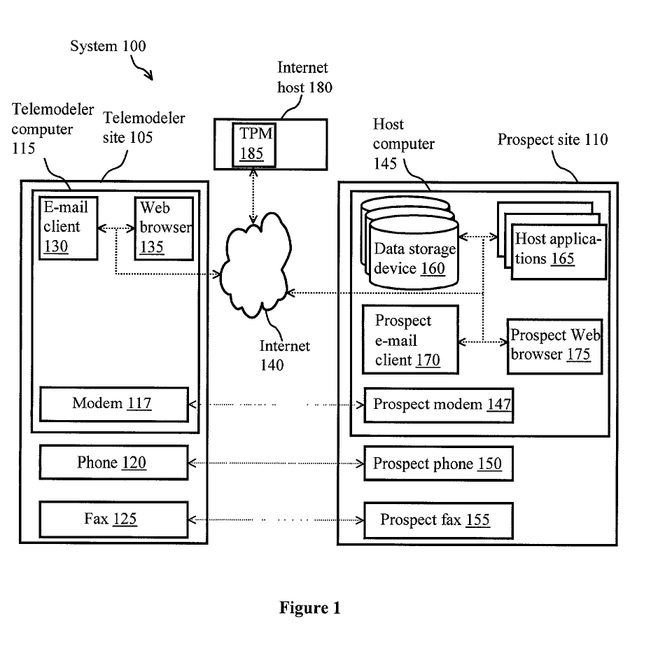

In one aspect, the invention is a system, a preferred embodiment of which is depicted in FIG. 1, for preparing a TPM for a data stream transformation, which includes a telemodeler site 105, a prospect site 110, and an Internet host 180. A “telemodeler” is a person who acquires the necessary information for and prepares a TPM 185, which is stored at Internet host 180. Telemodeler site 105 includes a telemodeler computer 115, a phone 120, and a fax machine 125. Telemodeler computer 115 further includes a modem 117, an e-mail client 130 and a Web browser 135. Telemodeler computer 115 connects to prospect site 110 either using e-mail client 130 or Web browser 135 via the Internet 140, or using modem 117 to dial directly into prospect site 110.

Again referring to FIG. 1, prospect site 110 includes host computer 145, a prospect phone 150, and a prospect fax machine 155. Prospect computer 145 further includes a prospect modem 147, data storage device 160, host applications 165, prospect e-mail client 170, and a prospect Web browser 175.

In operation, the telemodeler can communicate with a prospect in several ways. The telemodeler can use e-mail client 130 to send messages to prospect e-mail client 170 via Internet 140. The telemodeler also has the option of communicating or sending messages using phone 120 or fax machine 125. The prospect receives messages via prospect phone 150 or prospect fax machine 155, respectively. The telemodeler may also use modem 117 to connect directly to host computer 145 via prospect modem 147, which enables the telemodeler to access components of host computer 145, including data storage device 160 and host applications 165. Other forms of communicating with the prospect, such as via a T1 line, are also within the scope of the invention.

The telemodeler completes the information acquisition and drafts a TPM 185, which is posted on a Web site hosted by an Internet host 180. A prospect can view TPM 185 using the prospect Web browser 175 in order to review and approve the proposed data stream transformation.

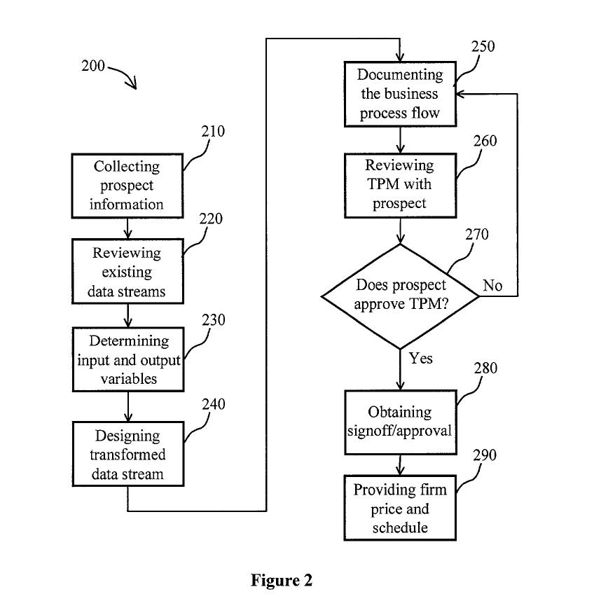

FIG. 2 is a flowchart showing a method 200 for preparing TPM 185 for a data stream transformation, which includes the steps below.

Step 210: Collecting Prospect Information

In this step, the telemodeler collects information needed to initiate development of TPM 185. The telemodeler may call the prospect company on phone 120, or can communicate via e-mail client 130 or fax machine 125. The prospect identifies the business purpose of the data stream transformation and the goals to be achieved by the process. Examples of business purposes include application integration, Web enablement, wireless data migration, public interface transformation, voice interaction, and machine control. The prospect may have additional business goals including removal of non-value added steps, reduction in errors, enhancement of functionality, or enhancement of security.

The devices being used, current file formats, and applications used are all specified by the prospect. The prospect provides contact information for all the key personnel related to the data stream transformation within the organization. Examples include the project manager, IS contacts, and financial department contacts. Host ID addresses and logon details are also provided to the telemodeler for use in subsequent steps.

Step 220: Reviewing Existing Data Streams

In this step, the telemodeler reviews hard or soft copies of each data stream to be transformed for the prospect. The prospect can provide the data stream information by faxing or e-mailing screen shots of host applications 165 in operation, or the telemodeler can access host computer 145 directly via modem 117 to view host applications 165 and review the data streams “live.” The telemodeler reviews the existing data streams to help ascertain the status of the prospect's host applications 165 and to determine what actions will meet the prospect's goals as defined in step 210.

Step 230: Determining Input and Output Variables

In this step, the telemodeler works with the key contacts at the prospect company via phone, fax, or e-mail to identify the input and output variables needed to satisfy and update the existing data streams. The size, type, and number of each variable needs to be defined. For example, an input variable could be a user identification number that is six characters in length, and is an alphanumeric data type. After defining the nature of each input and output variable, the telemodeler may “exercise” the existing host application by using input variables to determine the system response. This process may take days to complete, but is critical to the success of the following design step.

Step 240: Designing Transformed Data Stream

In this step, the telemodeler works with the prospect to define the specific characteristics of the transformed data stream. The two parties discuss how each transformed data stream will satisfy the business purposes as defined in step 210. The telemodeler takes the profile of the existing data streams as defined in step 220 and, recognizing the required input and output variable data from step 230, creates a design that satisfies the business purposes from step 210 as efficiently as possible. Using his/her own judgment and experience, the telemodeler assimilates the information from all preceding steps, and designs the transformed data stream with iterative feedback from the prospect via phone, fax, and e-mail. The iterative process allows more creative development between the telemodeler and the prospect.

Step 250: Documenting the Business Process Flow in the TPM

In this step, the telemodeler formally documents the design created in step 240 after receiving a tentative verbal approval from the prospect. The telemodeler describes the existing data streams, the input and output variable data, the proposed transformed data stream, and the business processes (as discussed above in steps 220 through 240) in one document that details the relationship between all the elements. This document is the TPM 185, defined as a documented description of the parameters for the data stream transformation with version control. TPM 185 is composed in HTML and posted at Internet host 180, but may also be written using a word processor and transmitted by email, for example.

Step 260: Reviewing TPM with Prospect

In this step, the prospect reviews TPM 185 and interacts with the telemodeler to discuss comments on the proposed data stream transformation. The telemodeler and the prospect may review the TPM via e-mailed copies of the document, or may simultaneously view the TPM via the Internet. This step may include both technical and/or sales force personnel from the telemodeler company to respond to a prospect's questions.

Step 270: Does Prospect Approve TPM?

In this step, the prospect approves the TPM, or requests changes in the TPM prior to approval. If the prospect approves the TPM, the method continues to step 280. If the prospect does not approve the TPM, the method returns to step 250 for the telemodeler to rewrite the TPM in accordance with the prospect's comments.

Step 280: Obtaining Signoff/Approval

In this step, a physical quote, an end user license agreement, and a schedule are provided to the prospect via e-mail, fax, or regular mail for the prospect to approve and sign and transmit back to the telemodeler.

Step 290: Providing Firm Price and Schedule

In this step, the telemodeler provides a contract to the prospect to complete the work as described in the quote, end user license agreement, and schedule.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A system for remotely preparing a targeted procedures model for transforming data streams, comprising:
a telemodeler site including a phone, a fax machine, and a telemodeler computer, further including a modem, an email client and a Web browser;
a prospect site including a prospect phone, prospect fax machine, and a host computer communicatively connected to the telemodeler computer, further including a data storage device, a prospect modem, database, host applications and data streams, prospect email client and Web browser;
an Internet host for storing a targeted procedures model communicatively connected to the telemodeler computer and host computer; and
wherein a telemodeler may remotely prepare a targeted procedures model by executing the steps of:
remotely collecting prospect information regarding the data streams at the prospect site;
reviewing prospect information regarding data streams and/or accessing the host computer directly via the modem to view the host applications and data streams in operation in order to determine goals;
determining input and output parameters necessary to satisfy the goals and to transform the data streams;
exercising the host application;
designing proposed transformed data streams using the input and output parameters that satisfy the goals;
documenting the data streams, input and output parameters, proposed transformed data streams and the goals in the targeted procedures model on the Internet host;
reviewing the targeted procedures model with a prospect;
deciding whether the prospect approves the targeted procedures model, and if the prospect does not approve returning to the documenting step;
obtaining the prospect's approval; and
providing a firm price and schedule.

2. The system of claim 1, wherein the telemodeler computer is communicatively connected to the host computer via the Internet.

3. A method of using a telemodeling system to remotely prepare a targeted procedures model for transforming data streams, the telemodeling system including a remote telemodeler site, a prospect site further including a host computer operating a host application and generating data streams and communicatively connected to the telemodeler computer, and an Internet host communicatively connected to the telemodeler computer and host computer, the method comprising the steps of:
remotely collecting prospect information regarding data streams at the prospect site;
reviewing prospect information regarding data streams or accessing the host computer directly to view the data streams in operation to determine goals;
determining input and output parameters necessary to satisfy the goals and to transform the data streams by exercising the host application;
designing proposed transformed data streams using the input and output parameters that satisfy the goals;
documenting the data streams, input and output parameters, proposed transformed data streams and the goals in a targeted procedures model on the Internet host;
reviewing the targeted procedures model with a prospect;
deciding whether the prospect approves the targeted procedures model, and if the prospect does not approve returning to the documenting step;
obtaining the prospect's approval; and
providing a firm price and schedule.
